(19) United States
(12) Patent Application Publication
(10) Pub. No.: US 2018/0331984 A1
(43) Pub. Date: Nov. 15, 2018

(54) Encrypted Pixilated Color(s) Communication Message Translator

(71) Applicant: Rachel McCall, La Grande, OR (US)

(72) Inventor: Rachel McCall, La Grande, OR (US)

(21) Appl. No.: 15/592,011

(22) Filed: May 10, 2017

(51) Int. Cl. H04L 12/58

(52) U.S. Cl. CPC H04L 51/08; H04L 51/12

(57) ABSTRACT

Embodiments can present message to a receiver with a color to reflect a mood and/or an action of the sender of the message. The system can enable the sender to select a mood or action to represent his/her mood or intended action when sending the message to the receiver. The system can enable the receiver to select a personalized color for presenting the message to reflect the mood or intended action of the sender. In some embodiments, the system can analyze a communication between the receiver and the sender to determine what mood(s) or actions(s) were during the communication. A result of the analysis can be presented to an interested party for review. In some embodiments, the system can enable the receiver to select one or more colors such that incoming messages of those colors will be bounced back to the sender(s).

### BACKGROUND OF THE INVENTION

This invention relates to messaging. More specifically this invention relates to presenting a message to reflect a mood and/or an action of a sender of the message.

Computing devices, such as mobile phones, portable and tablet computers, entertainment devices, handheld navigation devices, and the like are commonly implemented with on-screen keyboards (e.g., soft keyboards) that may be employed for text input and/or other interaction with the computing devices. Today, users are increasingly using emoji in web pages, emails, text messages, and other communications. Emoji as used herein refer to ideograms, smileys, pictographs, emoticons, and other graphic characters/representations that are used in place of textual words or phrases.

Researchers have found that color can affect someone's moods, feelings, and emotions. However, how people are affected by different color stimuli varies from person to person. There is evidence that color preference may also depend on ambient temperature. People who are cold prefer warm colors like red and yellow while people who are hot prefer cool colors like blue and green. A few studies have shown that cultural background has a strong influence on color preference. These studies have shown that people from the same region regardless of race will have the same color preferences. Also, one region may have different preferences than another region (i.e., a different country or a different area of the same country), regardless of race. Children's preferences for colors they find to be pleasant and comforting can be changed and can vary, while adult color preference is usually non-malleable. Common associations connecting a color to a particular mood may differ cross-culturally.

Existing messaging technologies typically do not allow a user—i.e., a sender to select a color to reflect his/her mood while messaging with another. When a receiver receives a text message from sender, the receiver often has to derive the emotional state of the sender from the meaning of the message. While the sender may insert Emoji in the message, an individual Emoji may not be sufficient to reflect the sender's emotion, especially when the message is long. Excessive use of Emoji in the message can also obscure the meaning of the message and makes the message more difficult to understand.

### BRIEF SUMMARY OF THE INVENTION

Some embodiments provide a system that can present message to a receiver with a color to reflect a mood and/or an action of the sender of the message. The message can include a text message, a message with multimedia contents (e.g., picture, video, audio, and/or Emoji). The system can enable the sender to select a mood or action to represent his/her mood or intended action when sending the message to the receiver. The system can enable the receiver to select a personalized color for presenting the message to reflect the mood or intended action of the sender. In some embodiments, the system can analyze such a “colored” communication between the receiver and the sender to determine what mood(s) or actions(s) were during the communication. In those embodiments, a result of the analysis can be presented to an interested party such as a parent, a teacher, a marketer for a review. The analysis may be used for self-monitoring to aid user in conversation navigation or behaving shaping. In some embodiments, the system can enable the receiver to select one or more colors such that incoming messages of those colors will be bounced back to the sender(s). In some embodiments, the system can enable a user to search for portion of communications by a particular mood or action.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 illustrates an exemplary system configured to present a message with a color to reflect a mood and/or an action of the sender of the message in a centralize architecture.

FIG. 2 illustrates an exemplary interface configured to enable the user to select a mood/action and a color for sending and/or receiving a message.

FIG. 3A-B illustrate two examples of presenting a message an interface with a color to reflect the mood or action of the sender.

FIG. 4A illustrates one example of a pie chart showing percentages of different moods and actions in a communication between the sender and receiver.

FIG. 4B illustrates one example of an interface that can show a result of a search specified by a user by selecting a color cue shown in the pie chart

FIG. 5 illustrates an exemplary method for presenting a message with a color to reflect a mood and/or an action of a sender.

FIG. 6 is a block diagram of computer system that can be used to implement various embodiments described and illustrated herein.

### DETAILED DESCRIPTION OF THE INVENTION

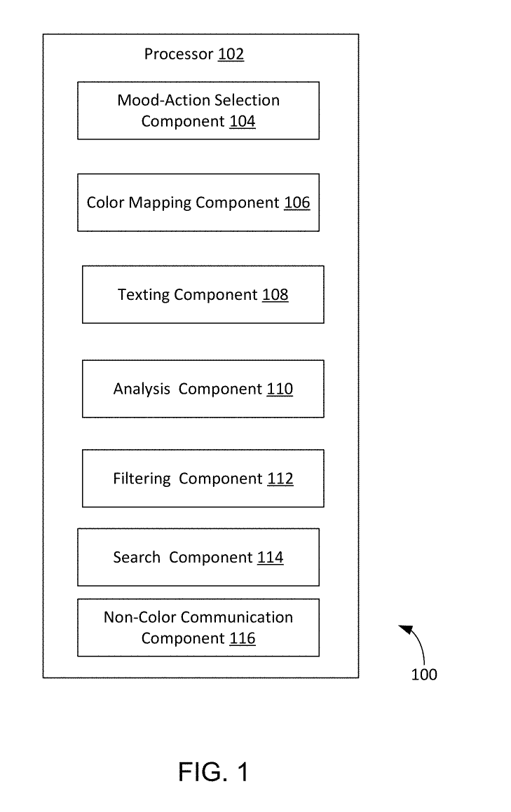

Embodiments can provide a system for presenting a message with a color to reflect a mood and/or an action of the sender of the message. For achieving this, the system can enable the sender to select a mood or action to represent his/her mood or action when messaging to the receiver. The message can include a text message, a message with multimedia contents (e.g., picture, video, audio, and/or Emoji). The system can enable the receiver to select a personalized color for presenting the message to reflect the mood of the sender. In some embodiments, a distributed architecture may be employed such that operations that can facilitate the sender to select the mood or action for messaging may be implemented on a device (e.g., a smartphone) associated with the sender. In those embodiments, operations that can present the message from sender to reflect the sender's mood or action with a personalized color of the receiver may be implemented on a device associated with the receiver. FIG. 1 illustrates an exemplary system 100 configured to present a message with a color to reflect a mood and/or an action of the sender of the message in a centralize architecture. That is, the sender operations and the receiver operations are illustrated as being both implemented by the system 100 in this example. However, this is not intended to be limiting. As mentioned above, the operations attributed to system 100 herein can be implemented on the devices associated with the receiver and the sender separately.

As shown, in some embodiments, the system 100 may include one or more of a processor 102 configured to program components, which may include a mood-action selection component 104, a color mapping component 106, a messaging component 108, an analysis component 110, a filtering component 112, a search component 114 and/or any other components. The mood-action selection component 104 can be configured to enable a user to select a mood or an action to reflect his/her mood or intended action when sending the message to another user. In some embodiments, the mood-action selection component 104 can enable the user to select a color for association with a particular mood or an intended action. It should be understood the user may be a sender in some instances as he/she sends the messages to another user and the user may be a receiver in some instances as he/she receives the messages from another user. The mood-action selection component 104 can enable the user to select the mood or action when sending the messages dynamically.

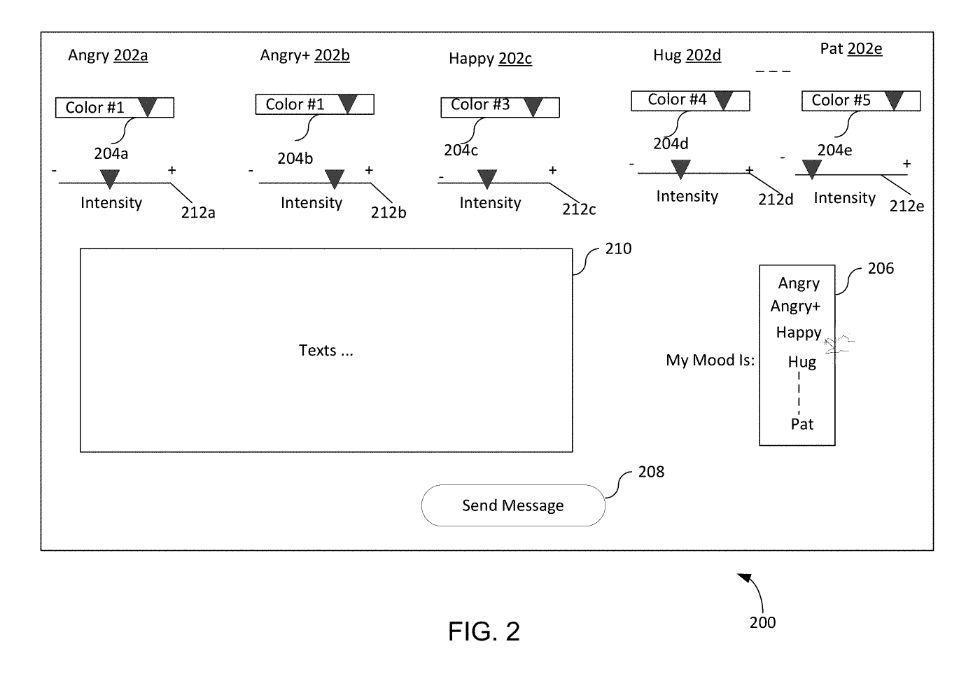

FIG. 2 illustrates an exemplary interface 200 configured to enable the user to select a mood/action and a color for sending and/or receiving a message. The interface 200 may be implemented on a device associated with the user, such as a smart phone of the user. As shown, the interface 200 may include one or more representations 202 (e.g., text description or graphic icons) of different moods and/or actions. In this example, moods 202a-c are shown just to illustrate a few examples of the different moods of the sender that can be reflected in the text message in accordance with the disclosure. Similarly, actions 202d-e are shown just to illustrate a few examples of the different actions that can be intended by the sender in the text message in accordance with the disclosure. These examples by no means are intended to be limiting. One skilled in the art will understand other moods and actions may be reflected and intended in the text message in accordance with the disclosure.

As also shown in FIG. 2, field controls, such as drop down menus 204a-e can be provided in the interface 200 to enable the user to select a personalized color to be associated with a particular mood. As mentioned above, different users may have different color preferences for representing different moods. Interface 200 thus can enable the user to select a color of his/her choice for representing a particular color. For example, the user may select red for representing angry, orange for representing positive, blue for representing the intended action is hugging and white for representing the intended action is patting. The interface 200 can also enable the user change the color preference for the particular mood or action dynamically. For example, the user may change from red to yellow for representing angry.

As also shown in FIG. 2, controls, such as 212a-e, may be provided in interface 200 to enable a user select an intensity level of a color selected by the user. The intensity level selected by the user may represent a scale of the particular mood corresponding to the color as selected by the user. In some implementation, the controls 212a-e, may be preset at a default position to represent a default state of the moods or actions corresponding to the colors controlled by the controls 212a-e. For example, the user may select red to represent angry, and a medium intensity level for the red may be preset to represent a default level or neutral level of angry. In some embodiments, the user may be enabled adjust the intensity level by adjusting the controls 212a-e for representing different states of the mood or action. For example, as shown in this example, the user is enabled to adjust the intensity level higher than the default level (e.g., the intenstity level of control 212a) for setting an angry+ state, which shows the user is “angrier” than the default or neutral angry, by adjusting control 212b. Likewise, as shown, the user can be enabled to adjust the intensity level lower than the default level for setting an angry− state, which can show the user is less angry than the default angry. The number of levels for a mood or an action that can be set by the user through interface 200 is not limited. There can be as many levels for the mood or the action as desired by the user. For example the user may be enabled to set three different levels of “angry” pluses—e.g., angry+++, angry++, and angry+; and 2 levels of “angry” minuses—e.g., angry−−, and angry−, by adjusting the intensity level of the color (e.g., red) corresponding to “angry” as selected by the user.

As also shown in FIG. 2, a field control 206, such as another drop down menu, can be provided in interface 200 to enable the user to select a mood or an action to be associated with the text message to be sent by the user to another user. In this example, the user is illustrated to select “happy” to represent his/her mood when sending the text message. As shown, after the user selects the mood in the drop down menu 206, the user can enter texts in the text box 210 and send the text message by acting on the “send message” button 208 provided in interface 200.

In some implementations, the text message may be associated with the mood or an action selected by the user during the communication. For example, a metadata tag may be inserted into the data of the text message to indicate the selected mood or action by the sender. After the text message is received by the device associated with the receiver, the metadata tag can be extracted from the text message to obtain the mood or action selected by the sender.

Referring back to FIG. 1, the color mapping component 106 can be configured to map a particular color to a particular mood as selected by the user. As illustrated in FIG. 2, the user can be enabled to select the particular color to be associated with the particular mood, e.g., red for angry and orange for positive. After such selections are made, the color mapping component 106 can be configured to store the selected color-mood associations in a storage associated with system 100, for example a memory storage. When an incoming text message is received, the color mapping component 106 can be configured to retrieve a color mapped to the mood of the text message (e.g., as indicated by a mood metadata tag in the text message) according to the stored color-mood associations selected by the user. As mentioned above, the user may associate a color with the particular mood or an action dynamically as he/she desires. That is, different colors may be selected by the user for different moods and/or different actions at different times during the communication. In some embodiments, the color mapping component 106 may be configured to create default associations between colors and moods and/or color and actions when the user selections have not been received. For example, by default, the color mapping component 106 may associate red with angry, orange with positive, grey with hugging, and so on. Such default associations can be changed after the user selections for these moods and/or actions are received from the interface described above.

The messaging component 108 can be configured to send a message that includes information indicating a mood of the user. As described above, messaging component 108 can be configured to insert a metadata tag to the message after the user pressed the “send message” button 208 to indicate the mood or action selected by the user through the drop down menu 206 as shown in FIG. 2. Messaging component 108 can be configured to present the message to the receiver with color selected by the receiver for indicating the mood or action selected by the sender. For example, the messaging component 108 may be configured to receive a color indication from the color mapping component 106 for presenting the received message to reflect the mood of the sender as being angry.

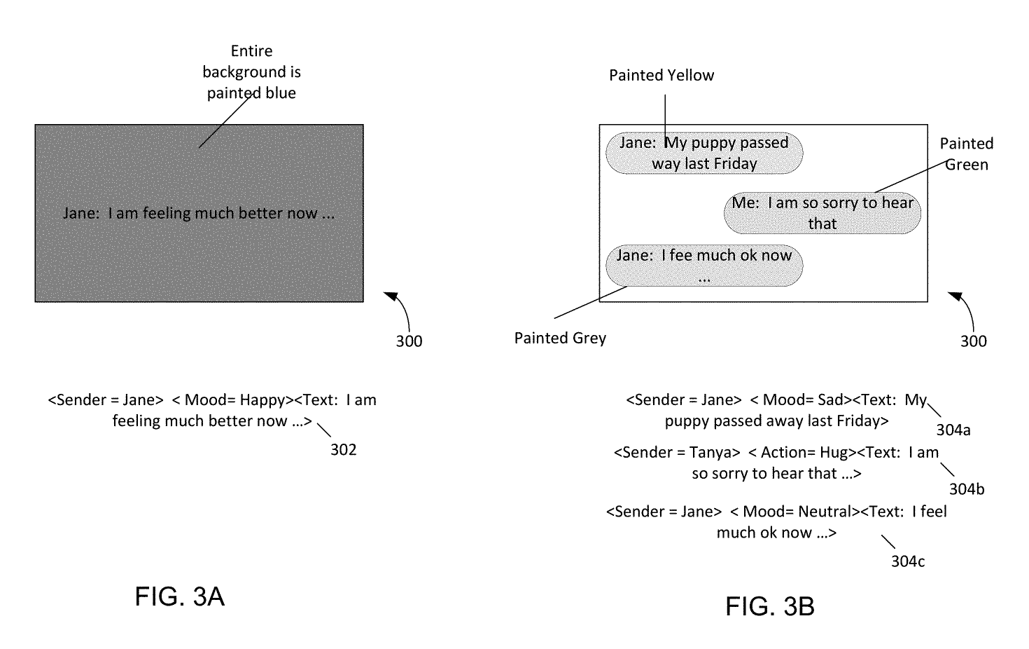

FIG. 3A-B illustrate two examples of presenting a message an interface 300 with a color to reflect the mood or action of the sender. The interface 300 may be implemented on a device (e.g., a smart phone) of the user. As shown, the text message 302 may include a metadata tag to indicate the sender's mood or action when sending the text message 302. As shown, after receiving such a text message, a personalized color (e.g., blue) as selected by the user can be used to display the text to reflect the sender's mood when sending the text message 302. In some implementations, as shown in FIG. 3A, the entire background of the interface 300 may be painted using the personalized color to reflect the mood or action of the sender. However, this is not necessarily the only case. In some other examples, a portion of the interface 300 (e.g., the portion of the texts where the text message is displayed in the interface 300) can be colored with the personalized color to reflect the mood or action of sender. This is illustrated in FIG. 3B. It should be understood in some embodiments, as shown in FIG. 3B, the receiver (i.e., Tanya shown un FIG. 3B) can set color preferences to display his/own mood or action when sending a particular message in the communication with the sender. It should also be understood the same messages 302 when displayed at the sender's device may have different colors as the receiver. Using the example illustrated in FIG. 3B, Jane may set grey for sad, orange for hugging, and white for neutral. Accordingly, the interface 300 may present the same messages 302 shown in FIG. 3B on Jane's device in those colors.

The analysis component 110 can be configured to analyze a particular communication between the sender and receiver and to determine one or more moods or actions associated with each of them during the communication. For example, the analysis component 110 can analyze the communication shown in FIG. 3B and to determine the mood(s) or actions(s) for Jane and Tanya when sending individual messages in the communication. In implementations, the analysis component 110 can examine the individual messages and extract the metadata tags from the messages for determining the moods and/or actions of the sender and/or receiver. However, this is not necessarily the only case. In some other implementations, the analysis component 110 can examine the actual display of the messages in the communication, determine colors for presenting each message, consulting the color mapping component 106 for moods or actions associated with the determined colors and determine the moods or actions based on the results from the color mapping component 106.

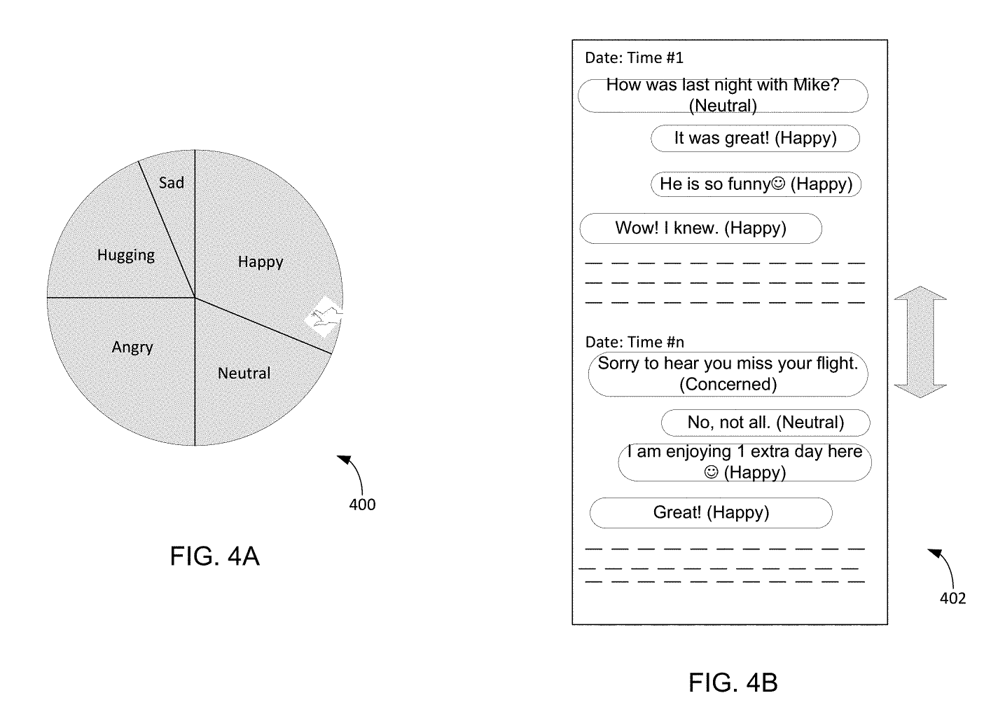

In some embodiments, the analysis component 110 can be configured to determine percentages of different moods or actions in a communication between the sender and the receiver. For example, the analysis component 110 can be configured to tally the number of messages that are sad, happy, hugging, neutral, angry and/or any other moods in the communication and determine a percentage for each type of these messages. In some embodiments, the analysis component 110 can be configured to present the percentages in a graphical representation such as a pie chart. FIG. 4A illustrates one example of a pie chart 400 showing percentages of different moods and actions in a communication between the sender and receiver.

The search component 114 can be configured to facilitate a search requested by the user. In some embodiments, the user may be enabled to request the search through an interface 402 shown in FIG. 4B. As shown in FIG. 4B, portions of the communications containing a particular mood may be displayed in the interface 402 after the user requests such a search. For example, the user may be enabled to click a particular mood (e.g., happy) shown in the pie chart in FIG. 4A to request the search. After the search request is received, the search component 114 can be configured to search through the communications and find one or more portions of the communication containing the mood selected by the user. In some implementations, as shown in FIG. 4B, all of the communications containing the mood selected by the user may be displayed in interface 402 and the user may scroll (or swipe) up and down the search results shown in the interface 402. As also shown, for a particular portion of the communication displayed in the interface 402, one or more contextual message surrounding the communications containing the mood selected by the user.

In some implementations, the analysis component 110 can be configured to detect certain type of messages has breached a threshold and notify a party of interest of such a breach. For example, a threshold may be set such that when the percentage of messages where the moods are angry (receiver and/or the sender) in the communication between the sender and the receiver has breached 30% of total messages in the communication as determined by the analysis component 110, a notification may be generated to a supervisor (e.g., a parent, a care-giver, a teacher). The threshold may be preset by the interested party or may be set by default. The threshold may not necessarily be a percentage number. It may include an absolute number. For example, a threshold of 10 may be set such that when the total number “angry” messages between the sender and receiver have breached 10, a notification may be generated to the supervisor.

Still as example, a notification may be generated to a business operator or a marketer when certain mood is detected in the communication between the sender and receiver by the analysis component 110. For instance, the analysis component 110 may be configured to send a notification to a particular local flower shop to indicate that the mood in the communication between the sender and the receiver has been detected as romantic and the total number of “hugging” messages sent by the sender in the communication has breached a threshold of 20. This can present the business operator an opportunity to market specific products to the sender and/or receiver based on the detected mood in the communication. For example, an offer of a special kind of flowers may be sent to the sender of romantic messages based on the sender has sent more than 20 “hugging” messages to the receiver.

The filtering component 112 can be configured to filter one or more types of messages in the communication between the sender and receiver. For example, the receiver may set a filter to indicate that he/she does not want to receive messages from the sender if those messages are indicated as angry by the sender. In that example, the filter component 112 can facilitate the user to set such a filter and monitor the incoming messages from the sender using the filter. When a particular message from the sender is detected as angry, the component 112 can be configured to bounce the message or not present the message to the receiver according to the filter. It should be understood the filter set by the receiver may be secret to the sender such that the sender may not be aware that his/her message was not presented to the receiver in the communication due to the filter set by the receiver.

In some embodiments, the filtering by the filtering component 112 may be contextual based on one or more phrases in the incoming message. For example, the receiver may be enabled to set a filter to specify if a certain phrase (e.g., a swearing phrase) appears in an angry message sent by the sender, the message may be bounced or not presented to the receiver. In that example, if the phrase appears in a non-angry message, that message will be presented to the receiver. Combinations of the mood and other aspects of the sender are also contemplated. For example, the mood can be combined with a specific sender to create a filter. For example, the receiver may be enabled to set a filter to specify if a swearing phrase is detected in a message of any mood from a minor contact (e.g., a 11 old niece of the receiver), the message will be explicitly bounced so that the minor contact can be notified this type of message is not appropriate in the communication. Such a filter can help shape a proper communication etiquette of the minor contact when texting.

In some implementations, the communications encoded with colors in accordance with the disclosure may be received by a system or device that doesn't show communications in colors. In those implementations, a non-color communication component 116 may be provided to translate the color coded communications to a format that can be accepted by such a system or device. For example, when a message is color coded yellow to show the user's mood is happy. This message may be translated by the non-color communication component 116 to remove the color code for a device that does not display color for communications. In some implementations, the non-color communication component 116 may be configured to translate the color to corresponding texts describing the mood coded by that color. For example, a yellow message may be translated to happy as a description associated with the message to facilitate the device that does not display colors in communications.

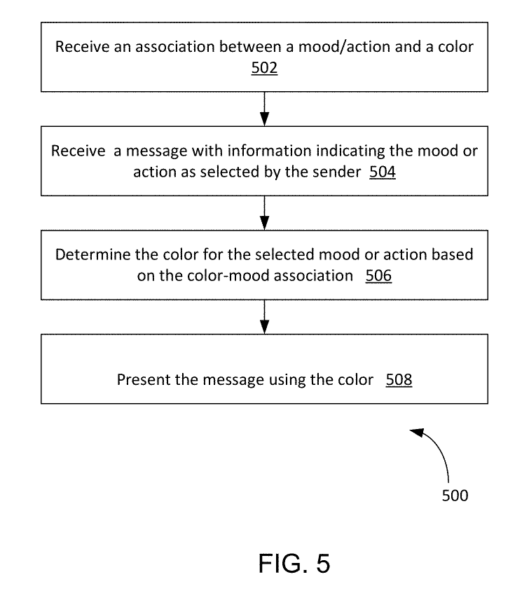

With the general architecture of a system for presenting a message with a color to reflect a mood and/or an action of the sender having been generally described, attention is now directed to FIG. 5, where an exemplary method for presenting such is illustrated. The method presented in FIG. 5 and described below is intended to be illustrative and non-limiting. The particular series of processing steps depicted in FIG. 5 is not intended to be limiting. It is appreciated that the processing steps may be performed in an order different from that depicted in FIG. 5 and that not all the steps depicted in FIG. 5 need be performed.

In some embodiments, the method depicted in method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At 502, an association between a mood or action, and a color can be received from a user. As described above, an interface, such as interface 200 shown in FIG. 2, can be used to enable the user to set the color-mood or color-action association received at 502. In some implementations, operations involved in 502 can be implemented by a color mapping component the same as or substantially similar to the color mapping component 106 described and illustrated herein.

At 504, a message can be received from a sender. The message received at 504 can include information indicating a mood or an action selected by the sender. As described above, an interface, such as interface 200 shown in FIG. 2, can be used to enable the sender to select the mood when sending the text message. After the sender selects the mood, the text message can be generated to include information, such as a metadata tag shown FIGS. 3A and 3B to indicate the mood selected by the sender. Such a message can then be received by a device (e.g., a smart phone) associated with the receiver at 504. In some implementations, operations involved in 504 can be implemented by texting component the same as or substantially similar to the messaging component 108 described and illustrated herein.

At 506, the color for the mood selected by the sender as indicated by the text message received at 504 can be determined based on the color-mood or color-action association received at 504. In some implementations, operations involved in 506 can be implemented by a color mapping component the same as or substantially similar to the color mapping component 106 described and illustrated herein.

At 508, the message received at 504 can be presented in the color determined at 506 to reflect the mood or the action of the sender when sending the message. In some implementations, operations involved in 508 can be implemented by texting component the same as or substantially similar to the messaging component 108 described and illustrated herein.

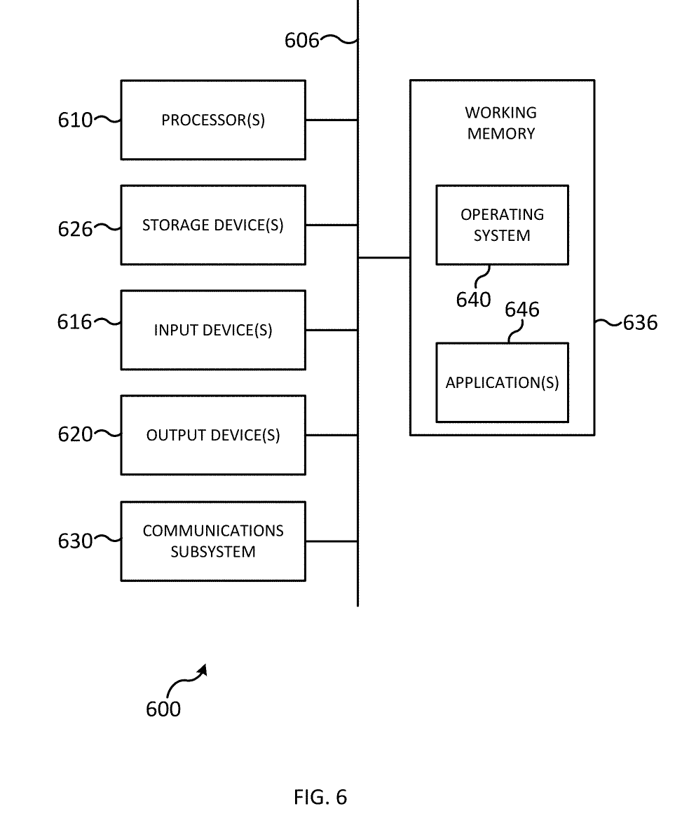

FIG. 6 is a block diagram of computer system 600 that can be used to implement various embodiments described and illustrated herein. FIG. 6 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 600 and any of its components or subsystems can include hardware and/or software elements configured for performing methods described herein.

Computer system 600 may include familiar computer components, such as one or more one or more data processors or central processing units (CPUs) 605, one or more graphics processors or graphical processing units (GPUs) 610, memory subsystem 615, storage subsystem 620, one or more input/output (I/O) interfaces 625, communications interface 630, or the like. Computer system 600 can include system bus 635 interconnecting the above components and providing functionality, such connectivity and inter-device communication.

The one or more data processors or central processing units (CPUs) 605 can execute logic or program code or for providing application-specific functionality. Some examples of CPU(s) 605 can include one or more microprocessors (e.g., single core and multi-core) or micro-controllers, one or more field-gate programmable arrays (FPGAs), and application-specific integrated circuits (ASICs). As used herein, a processor includes a multi-core processor on a same integrated chip, or multiple processing units on a single circuit board or networked.

The one or more graphics processor or graphical processing units (GPUs) 610 can execute logic or program code associated with graphics or for providing graphics-specific functionality. GPUs 610 may include any conventional graphics processing unit, such as those provided by conventional video cards. In various embodiments, GPUs 610 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 610 may include any number of registers, logic units, arithmetic units, caches, memory interfaces, or the like.

Memory subsystem 615 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 615 can include data and program code 640.

Storage subsystem 620 can also store information using machine-readable articles, information storage devices, or computer-readable storage media. Storage subsystem 620 may store information using storage media 645. Some examples of storage media 645 used by storage subsystem 620 can include floppy disks, hard disks, optical storage media such as CD-ROMS, DVDs and bar codes, removable storage devices, networked storage devices, or the like. In some embodiments, all or part of data and program code 640 may be stored using storage subsystem 620.

The one or more input/output (I/O) interfaces 625 can perform I/O operations. One or more input devices 650 and/or one or more output devices 655 may be communicatively coupled to the one or more I/O interfaces 625. The one or more input devices 650 can receive information from one or more sources for computer system 600. Some examples of the one or more input devices 650 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 650 may allow a user of computer system 600 to interact with one or more non-graphical or graphical user interfaces to enter a comment, select objects, icons, text, user interface widgets, or other user interface elements that appear on a monitor/display device via a command, a click of a button, or the like.

The one or more output devices 655 can output information to one or more destinations for computer system 600. Some examples of the one or more output devices 655 can include a printer, a fax, a feedback device for a mouse or joystick, external storage systems, a monitor or other display device, a communications interface appropriately configured as a transceiver, or the like. The one or more output devices 655 may allow a user of computer system 600 to view objects, icons, text, user interface widgets, or other user interface elements. A display device or monitor may be used with computer system 600 and can include hardware and/or software elements configured for displaying information.

Communications interface 630 can perform communications operations, including sending and receiving data. Some examples of communications interface 630 may include a network communications interface (e.g. Ethernet, Wi-Fi, etc.). For example, communications interface 630 may be coupled to communications network/external bus 660, such as a computer network, a USB hub, or the like. A computer system can include a plurality of the same components or subsystems, e.g., connected together by communications interface 630 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

Computer system 600 may also include one or more applications (e.g., software components or functions) to be executed by a processor to execute, perform, or otherwise implement techniques disclosed herein. These applications may be embodied as data and program code 640. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 615 and/or storage subsystem 620.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A system for presenting a message with a color to reflect a mood and/or an action of the sender of the message, the system comprising a processor configured to execute computer programs such that when the computer programs are executed, the processor is caused to perform:
receiving, from a first user, an association between a first mood and a first color;
storing the association between the first mood and the first color in a storage device associated with the system for the first user;
receiving a first message from a second user via a network, the first message including information indicating the first mood as selected by the second user when sending the first message;
determining the first color for presenting the first message based on the association between the first mood and the first color; and
in response to the determination of the first color for the first message, effectuating presentation of the first message in the first color to reflect the first mood of the second user when sending the first message.

2. The system of claim 1, wherein the processor is further configured to perform:
receiving, from the first user, an association between a second mood and a second color;
receiving, from the first user, a second message to be sent to the second user, the second message including information indicating the second color;
translating the second color in the second message to the second mood based on the association between a second mood and a second color;
transmitting the second message to a communication device associated with the second user.

3. The system of claim 1, wherein the processor is further configured to perform:
receiving, from the first user, an association between a first action and a third color;
storing the association between the first action and the third color in a storage device associated with the system;
receiving a third message from a third user via a network, the first message including information indicating the first action intended by the third user when sending the third message;
determining the third color for presenting the third message based on the association between the first action and the third color; and
in response to the determination of the first color for the third message, effectuating presentation of the third message in the third color to show the first action intended by the third user when sending the third message.

4. The system of claim 3, wherein the first action includes hugging, patting, thumbing, or kissing.

5. The system of claim 1, wherein the processor is further caused to perform:
analyzing a set of messages having been exchanged between the first and second user; and
determining an amount of messages in the set the second user selected the first mood for presentation to the first user.

6. The system of claim 5, wherein the processor is further caused to perform:
comparing the amount with a predetermined threshold indicating a threshold number messages that can have the first mood;
in response to the amount exceeding the predetermined threshold, generating a notification indicating the predetermined threshold has been breached in the set of messages; and
transmitting the notification to a computing device associated with a third user.

7. The system of claim 1, wherein the processor is further caused to perform:
receiving from the first user a filter indicating a message containing a second mood is not to be presented to the first user;
receiving a second message from the second user via a network, the second message including information indicating the second mood as selected by the second user; and
in response to determining the second message containing the second mood, generating an instruction for not presenting the second message to the first user based on the filter.

8. The system of claim 7, wherein the filter further indicates the message has to be from the second user.

9. The system of claim 1, whether the processor is further caused to perform:
receiving, from the second user, an association between the first mood and a second color; and
storing the association between the first mood and the second color in a storage device associated with the system for the second user.

10. A method for presenting a message with a color to reflect a mood and/or an action of the sender of the message, the method being implemented by a processor, the method comprising:
receiving, from a first user, an association between a first mood and a first color;
storing the association between the first mood and the first color in a storage device associated with the system for the first user;
receiving a first message from a second user via a network, the first message including information indicating the first mood as selected by the second user when sending the first message;
determining the first color for presenting the first message based on the association between the first mood and the first color; and
in response to the determination of the first color for the first message, effectuating presentation of the first message in the first color to reflect the first mood of the second user when sending the first message.

11. The method of claim 10, wherein the processor is further configured to perform:
receiving, from the first user, an association between a second mood and a second color;
receiving, from the first user, a second message to be sent to the second user, the second message including information indicating the second color;
translating the second color in the second message to the second mood based on the association between a second mood and a second color;
transmitting the second message to a communication device associated with the second user.

12. The method of claim 10, further comprising:
receiving, from the first user, an association between a first action and a third color;
storing the association between the first action and the third color in a storage device associated with the system;
receiving a third message from a third user via a network, the first message including information indicating the first action intended by the third user when sending the third message;
determining the third color for presenting the third message based on the association between the first action and the third color; and
in response to the determination of the first color for the third message, effectuating presentation of the third message in the third color to show the first action intended by the third user when sending the third message.

13. The method of claim 12, wherein the first action includes hugging, patting, thumbing, or kissing.

14. The method of claim 10, further comprising:
analyzing a set of messages having been exchanged between the first and second user; and
determining an amount of messages in the set the second user selected the first mood for presentation to the first user.

15. The method of claim 14, further comprising:
comparing the amount with a predetermined threshold indicating a threshold number messages that can have the first mood;
in response to the amount exceeding the predetermined threshold, generating a notification indicating the predetermined threshold has been breached in the set of messages; and
transmitting the notification to a computing device associated with a third user.

16. The method of claim 10, further comprising:
receiving from the first user a filter indicating a message containing a second mood is not to be presented to the first user;
receiving a second message from the second user via a network, the second message including information indicating the second mood as selected by the second user; and
in response to determining the second message containing the second mood, generating an instruction for not presenting the second message to the first user based on the filter.

17. The method of claim 16, wherein the filter further indicates the message has to be from the second user.

18. The method of claim 10, further comprising:
receiving, from the second user, an association between the first mood and a second color; and
storing the association between the first mood and the second color in a storage device associated with the system for the second user.
